(19) United States
(12) Patent Application Publication
(10) Pub. No.: US 2025/0053068 A1
(43) Pub. Date: Feb. 13, 2025

(54) CAPTURING DEVICE

(71) Applicant: CASIO COMPUTER CO., LTD., Tokyo (JP)

(72) Inventors: Katsuyuki MATSUO, Tokyo (JP); Tohru YOSHIDA, Tokyo (JP)

(73) Assignee: CASIO COMPUTER CO., LTD., Tokyo (JP)

(21) Appl. No.: 18/798,960

(22) Filed: Aug. 9, 2024

(30) Foreign Application Priority Data
Aug. 10, 2023 (JP) 2023-131522

(51) Int. Cl. G03B 15/03; F21V 8/00

(52) U.S. Cl. CPC G03B 15/03; G02B 6/0008

(57) ABSTRACT

A capturing device includes: a light source that emits light applied to a capturing target; a capturing element that captures the capturing target; a capturing lens that couples an image of the capturing target to the capturing element; a light guide member that guides light emitted from the light source; and a holding member that is fixed inside the capturing device, and holds the light guide member. The light source is provided closer to the capturing element side than a tip of the capturing lens. The light guide member extends in parallel with an optical axis of the capturing lens, causes light from the light source to be incident on a light incidence portion, guides light in a direction parallel to the optical axis toward the tip of the capturing lens, and emits light from a light emission portion.

### CROSS-REFERENCE TO RELATED APPLICATION

This application claims the benefit of Japanese Patent Application No. 2023-131522, filed on Aug. 10, 2023, the entire disclosure of which is incorporated by reference herein.

### FIELD

The present disclosure relates generally to a capturing device.

### BACKGROUND

A technique for evaluating and diagnosing a state of skin of a person from an image in which the skin is captured is known (for example, Japanese Patent No. 5797921).

### SUMMARY

A capturing device according to the present disclosure includes: a light source that emits light applied to a capturing target; a capturing element that captures the capturing target; a capturing lens that couples an image of the capturing target to the capturing element; a light guide member that guides light emitted from the light source; and a holding member that is fixed inside the capturing device, and holds the light guide member, wherein the light source is provided closer to the capturing element side than a tip of the capturing lens, and the light guide member extends in parallel with an optical axis of the capturing lens, causes light from the light source to be incident on a light incidence portion, guides light in a direction parallel to the optical axis toward the tip of the capturing lens, and emits light from a light emission portion.

### BRIEF DESCRIPTION OF DRAWINGS

A more complete understanding of this application can be obtained when the following detailed description is considered in conjunction with the following drawings, in which:

FIG. 1 is a perspective view of a capturing device according to Embodiment 1 of the present disclosure;

FIG. 2 is a perspective view illustrating a state where a lens hood and a diffusion plate are removed from the capturing device illustrated in FIG. 1;

FIG. 3 is an exploded perspective view of the capturing device according to Embodiment 1 of the present disclosure;

FIG. 4 is a front view illustrating a state where the lens hood and the diffusion plate are removed from an illumination device of the capturing device according to Embodiment 1 of the present disclosure;

FIG. 5 is an end view of the illumination device taken along a cut line V-V in FIG. 4;

FIG. 6 is a perspective view illustrating a scene where a holder and a second LED substrate of the capturing device according to Embodiment 1 of the present disclosure are disassembled;

FIG. 7 is a front view focusing on the holder illustrated in FIG. 4 that holds a light guide;

FIG. 8 is a cross-sectional view illustrating a scene where light is applied while a tip of the lens hood of the capturing device according to Embodiment 1 of the present disclosure is in contact with a capturing target;

FIG. 9 is a front view illustrating a state where a lens hood and a diffusion plate are removed from an illumination device of a capturing device according to Embodiment 2 of the present disclosure;

FIG. 10 is an end view of the illumination device taken along a cut line X-X in FIG. 9; and

FIG. 11 is a perspective view illustrating a scene where a first light guide, a holder, and a second LED substrate of the capturing device according to Embodiment 2 of the present disclosure are disassembled.

### DETAILED DESCRIPTION

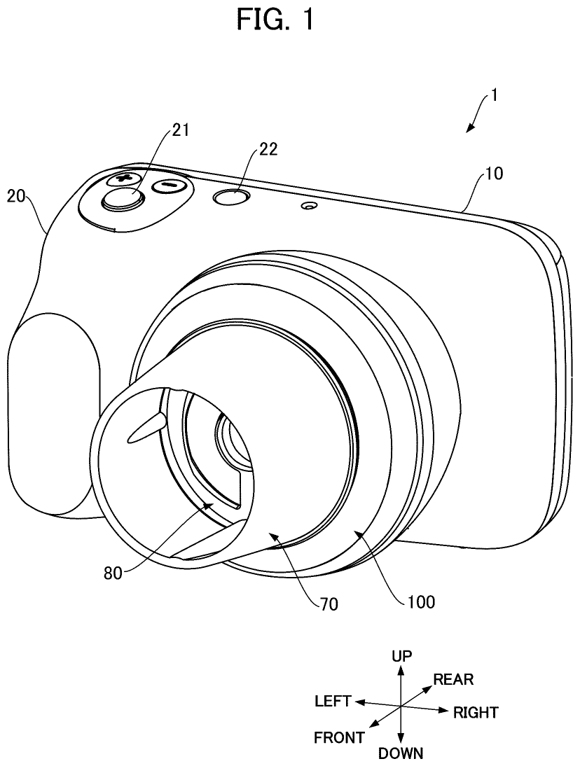

Hereinafter, a capturing device according to the embodiments of the present disclosure is described with reference to drawings. In the following description, as illustrated in FIG. 1, description is given based on an orthogonal coordinate system in which a capturing target (subject) side is the front (front surface, front face) of a capturing device 1, an opposite side is the rear, and up, down, left, and right directions when the capturing device 1 is viewed from the front are up, down, left, and right directions as they are.

### Embodiment 1

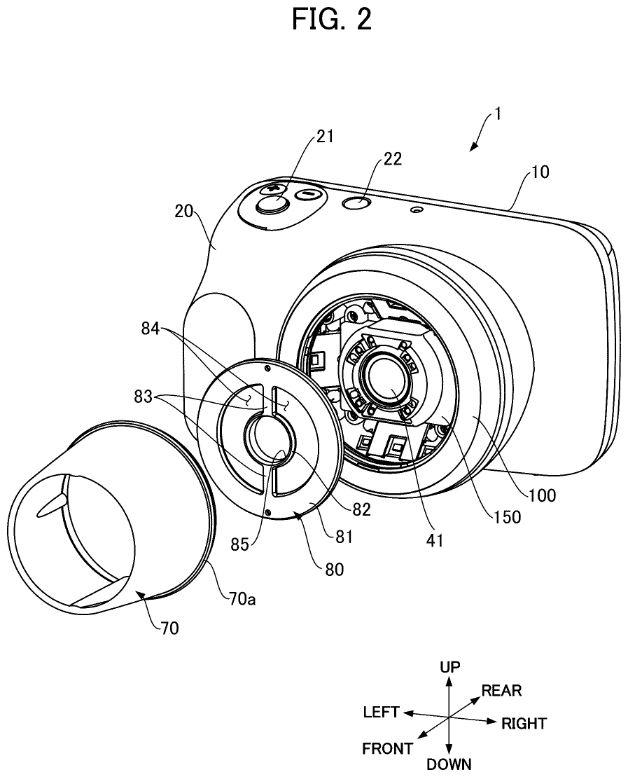

The capturing device 1 according to Embodiment 1 captures skin of a person as a capturing target. As illustrated in FIG. 2, the capturing device 1 includes a lens hood 70 and a diffusion plate 80 that are removable. A tip with the lens hood 70 being attached is brought into contact with skin, and thus the skin and the capturing device 1 in a predetermined positional relationship can be captured.

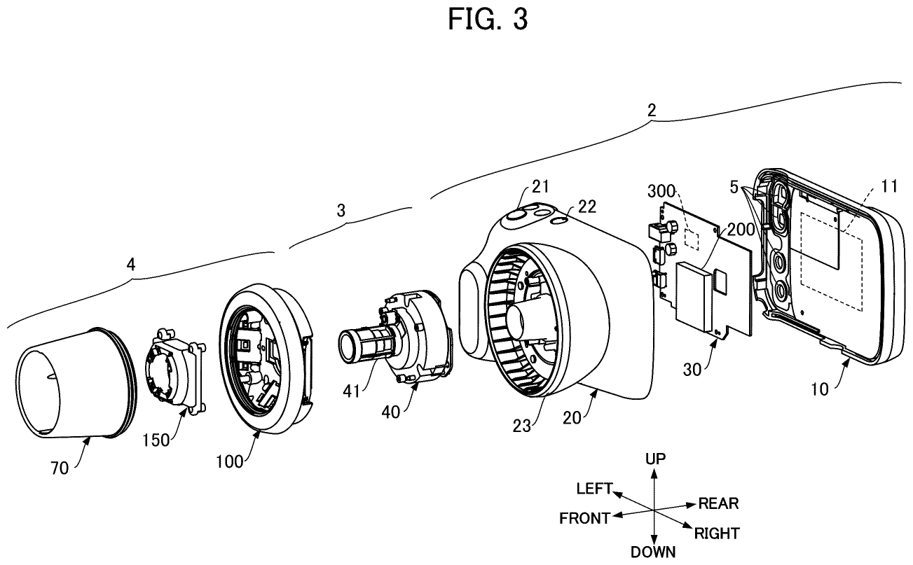

As illustrated in FIG. 3, the capturing device 1 includes a controller 2, a camera main body 3, and an illumination device 4 provided in front of the camera main body 3.

The controller 2 includes a display 10 provided with a liquid crystal monitor 11 of a touch panel type that displays various types of operation information and a captured image and also accepts an operation of a user, a main body 20 provided with operation buttons such as a shutter button 21 and a power button 22, and a circuit substrate 30 housed between the display 10 and the main body 20. A plurality of operation buttons 5 for operating each component from the rear is arranged in an up-down direction in the display 10. A cylinder 23 protruding to the front is provided on a front surface of the main body 20. The circuit substrate 30 is provided with a storage 200 that stores a captured image, and a control unit 300 that controls each component of the capturing device 1. The control unit 300 is, for example, a central processing unit (CPU).

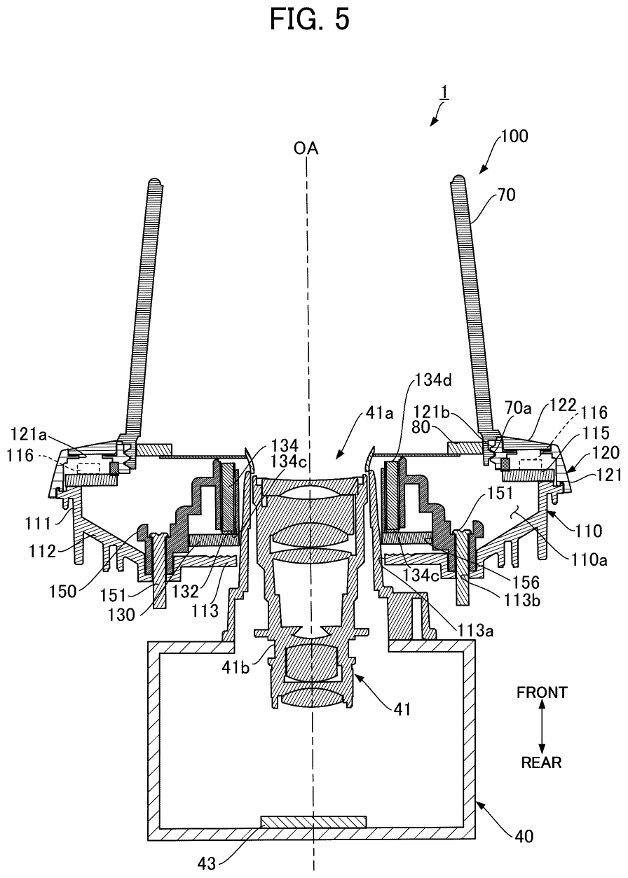

The camera main body 3 includes a capturer 40. The capturer 40 includes a capturing lens system 41 including a capturing lens group 41a. The capturing lens group 41a includes a plurality of lenses provided on an optical axis OA of the capturing lens group 41a. As illustrated in FIG. 5, a capturing element 43 is housed in the rear of the capturing lens system 41.

The capturing lens system 41 includes the capturing lens group 41a, and a lens tube 41b that houses the capturing lens group 41a. The capturing lens group 41a is interposed between skin being a capturing target and the capturing element 43, and couples an image of the capturing target to the capturing element 43. The capturing lens group 41a includes a lens movable in a front-back direction, and thus a focal distance changes, and a magnification can be changed.

The capturing element 43 is a known capturing element, and is, for example, a charge coupled device (CCD) image sensor, a complementary metal oxide semiconductor (CMOS) image sensor, and the like, and is configured to convert an optical image of a subject into an electric signal. The capturer 40 can capture a capturing target by using the capturing element 43. The capturer 40 can capture, for example, a still image and a moving image.

As illustrated in FIG. 3, the illumination device 4 includes an illumination device main body 100 attached to the main body 20 of the controller 2, a holder 150 provided on the illumination device main body 100, the lens hood 70 removable from the illumination device main body 100, and the diffusion plate 80 (FIG. 2).

As illustrated in FIG. 5, the illumination device main body 100 includes a base 110, and a cover 120 that covers a periphery of the base 110 and has an annular shape.

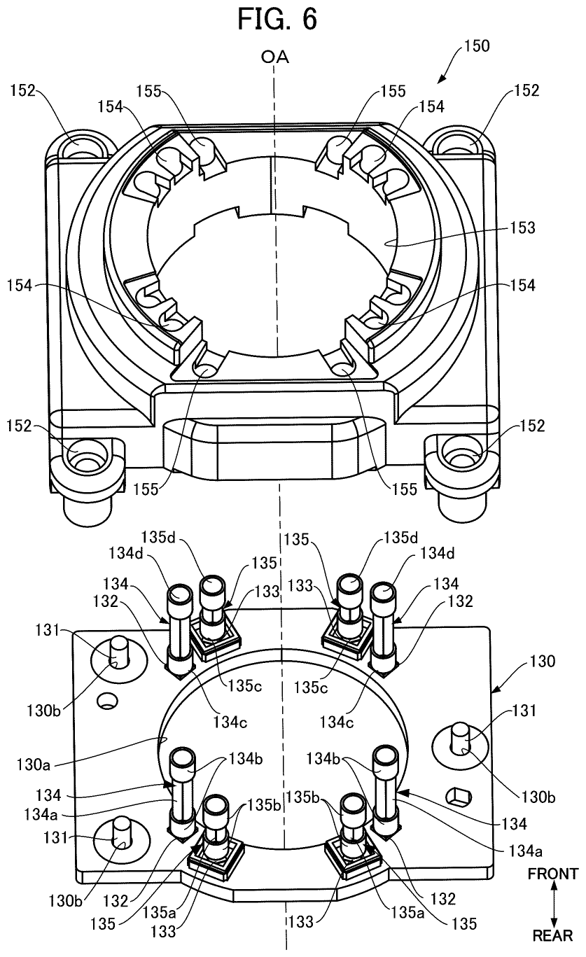

The base 110 is provided with a first LED substrate 115 and a second LED substrate 130 on which a light emitting diode (LED) serving as a light source is mounted, and the holder 150 that holds a first light guide 134 and a second light guide 135 (FIG. 6) that guide light emitted from the LED mounted on the second LED substrate 130. The base 110 is made of, for example, a black synthetic resin. The base 110 includes a cylinder 111, an inclined wall 112 extending obliquely rearward from a rear end of the cylinder 111, and a bottom wall 113 connecting the rear end of the inclined wall 112. The base 110 has a housing space 110a defined by an inner wall of the cylinder 111, an inner wall of the inclined wall 112, and an inner wall of the bottom wall 113 and used for housing various parts.

An outer diameter of the cylinder 111 is substantially the same as an inner diameter of the cylinder 23 of the main body 20 illustrated in FIG. 3, and an outer peripheral surface of the cylinder 111 is fitted with an inner peripheral surface of the cylinder 23. In this way, the base 110 is attached to the cylinder 23. As illustrated in FIG. 5, the first LED substrate 115 is placed on a tip of the cylinder 111.

The inclined wall 112 includes a plurality of wall bodies connecting a lower end of the cylinder 111 and the bottom wall 113. The plurality of inclined walls 112 facing in directions different from one another is connected to the bottom wall 113 from all sides.

The bottom wall 113 is a wall body facing the front, and constitutes a bottom of the base 110. The bottom wall 113 is provided with screw holes 113b for attaching the holder 150 at a total of four places. Further, a lens tube introduction hole 113a through which the lens tube 41b of the capturer 40 is introduced is provided at the center of the bottom wall 113.

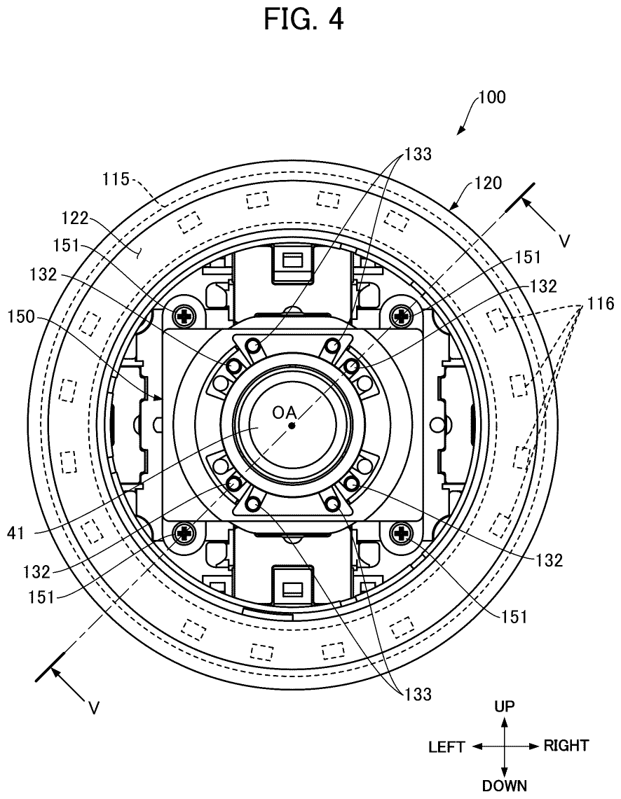

As illustrated in FIG. 4, the first LED substrate 115 is a disc-shaped substrate, and includes 16 LEDs 116 disposed in a circumferential direction. Note that, in order to clarify an installation position, the LEDs 116 are assumed to cross a cut line V-V in an end view of FIG. 5 and are illustrated by a chain double-dashed line. The LEDs 116 are, for example, LEDs that emit white light, and function as a ring flashlight that emits light from an outer peripheral position of the illumination device main body 100 to the front. The LEDs 116 apply light to skin when, as a general camera, the capturing device 1 in which the lens hood 70 and the diffusion plate 80 illustrated in FIG. 1 are removed performs capturing (first capturing) on the skin.

As illustrated in FIG. 5, the second LED substrate 130 is housed in a substrate housing 156 provided in the rear of the holder 150. The second LED substrate 130 provided in the rear of the holder 150 in such a manner is disposed closer to the rear (capturing element side) than a front end (tip) of the capturing lens system 41. The second LED substrate 130 is a substrate having a substantially rectangular outer shape as illustrated in FIG. 6, and has, at the center, a lens tube introduction hole 130a through which the lens tube 41b of the capturer 40 illustrated in FIG. 3 is introduced. The lens tube introduction hole 130a is a circular hole having the center coinciding with the optical axis OA. The second LED substrate 130 is fixed to the holder 150 from the rear by a screw 131. The second LED substrate 130 has three screw introduction holes 130b for passing the screw 131.

Further, the second LED substrate 130 is provided with four first LEDs 132 and four second LEDs 133 on a periphery of the lens tube introduction hole 130a. The first LED 132 and the second LED 133 emit light when capturing (second capturing) is performed while the tip of the lens hood 70 illustrated in FIG. 1 is in contact with skin.

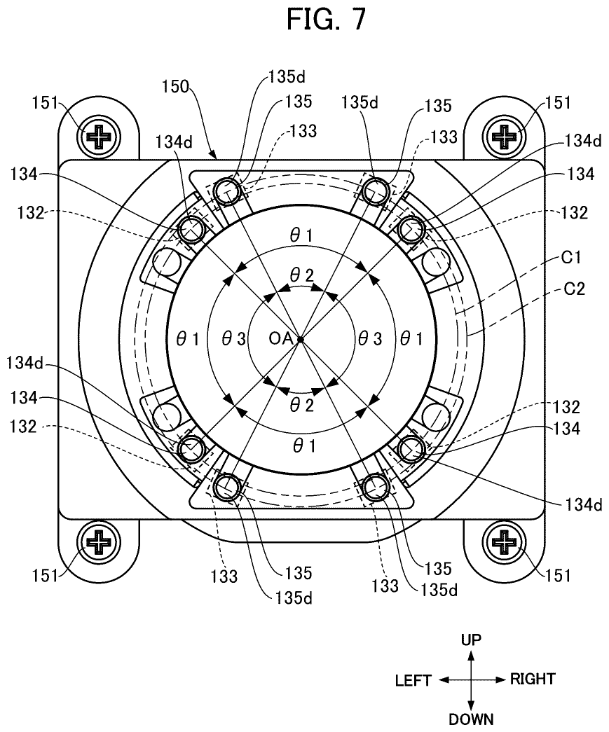

The first LED 132 emits white visible light. As illustrated in FIG. 7, when viewed from a direction parallel to the optical axis OA, the first LED 132 is disposed on a virtual circle C1 having the center coinciding with the optical axis OA. The first LED 132 is disposed for each angle of an angle θ1 with respect to the center of the virtual circle C1. The angle θ1 is 90 degrees. When an arrangement of the first LEDs 132 is described from a different viewpoint, the first LED 132 is provided on each vertex of a virtual square having the center coinciding with the optical axis OA.

The second LED 133 emits ultraviolet light. When viewed from the direction parallel to the optical axis OA, the second LED 133 is disposed on a virtual circle C2 having the center coinciding with the optical axis OA. A radius of the virtual circle C2 is larger than a radius of the virtual circle C1. The second LEDs 133 are disposed counterclockwise at intervals of an angle θ2, an angle θ3, the angle θ2, and the angle θ3 with respect to the center of the virtual circle C2. Herein, the angle θ2 is, for example, 52 degrees, and the angle θ3 is, for example, 128 degrees. When an arrangement of the second LEDs 133 is described from a different viewpoint, the second LED 133 is provided on each vertex of a virtual rectangle having the center coinciding with the optical axis OA.

In this way, the capturing device 1 is provided with the LEDs 116 that emit light when the first capturing being general capturing is performed, and the first LEDs 132 that emit visible light and the second LEDs 133 that emit ultraviolet light when the second capturing is performed by setting a distance between skin being a capturing target and the capturing device 1 as a predetermined distance.

Further, as illustrated in FIG. 6, the first light guide 134 is disposed as a light guide member in front of each of the first LEDs 132, and the second light guide 135 is disposed as a light guide member in front of each of the second LEDs 133.

The first light guide 134 includes an optical fiber bundle 134a including a plurality of optical fibers, and a binder 134b wound around both ends of the optical fiber bundle 134a. The binder 134b is, for example, a stainless pipe, but a member made of other metal or resin may be used for binding. A diameter of each of the optical fibers is, for example, 0.2 mm. A diameter of the optical fiber bundle 134a tying the optical fibers in a bundle is, for example, about 2.0 mm. Further, the capturing device 1 has a size of a general camera, and a length in the front-back direction of the first light guide 134 housed in the capturing device 1 is, for example, 5 mm to 10 mm. The first light guide 134 linearly extends in the front-back direction (direction parallel to the optical axis OA). One end of the first light guide 134 serves as a light incidence portion 134c and faces the first LED 132, and the other end serves as a light emission portion 134d and faces the front. The first light guide 134 causes light from the first LED 132 to be incident from the light incidence portion 134c on the inside, guides the light to the front (tip direction of the capturing lens system 41) while totally reflecting the light inside each of the optical fibers, and emits the light from the light emission portion 134d to the front. Note that, as illustrated in FIG. 7, when viewed from the direction parallel to the optical axis, each of the light emission portions 134d is disposed on the virtual circle C1 having the center coinciding with the optical axis OA and has an equal distance from the optical axis OA.

The second light guide 135 also has the same configuration as that of the first light guide 134, and includes, as illustrated in FIG. 6, an optical fiber bundle 135a including a plurality of optical fibers, and a binder 135b wound around both ends of the optical fiber bundle 135a. A diameter of each of the optical fibers is, for example, 0.2 mm. A diameter of the optical fiber bundle 135a tying the optical fibers in a bundle is, for example, about 2.0 mm. Similarly to the first light guide 134, a length in the front-back direction of the second light guide 135 is, for example, 5 mm to 10 mm. The second light guide 135 linearly extends in the front-back direction. One end of the second light guide 135 serves as a light incidence portion 135c and faces the second LED 133, and the other end serves as a light emission portion 135d and faces the front. The second light guide 135 causes light from the second LED 133 to be incident from the light incidence portion 135c on the inside, guides the light to the front while totally reflecting the light inside each of the optical fibers, and emits the light from the light emission portion 135d to the front. Note that, as illustrated in FIG. 7, when viewed from the direction parallel to the optical axis, each of the light emission portions 135d is disposed on the virtual circle C2 having the center coinciding with the optical axis OA and has an equal distance from the optical axis OA.

As illustrated in FIG. 5, the holder 150 as a holding member is fixed to the housing space 110a of the base 110 via a screw 151. As illustrated in FIG. 6, the holder 150 has a substantially rectangular planar shape viewed from the front, and has a screw introduction hole 152 for the screw 151 to be introduced in four corners. Further, as illustrated in FIG. 5, the substrate housing 156 being a recess for housing the second LED substrate 130 is provided in a surface (rear surface) facing the rear of the holder 150.

As illustrated in FIG. 6, the holder 150 has a lens tube introduction hole 153 through which the lens tube 41b (FIG. 3) of the capturer 40 is introduced, a first plug hole 154 into which the first light guide 134 is plugged, and a second plug hole 155 into which the second light guide 135 is plugged.

When viewed from the front, the lens tube introduction hole 153 is provided at the center of the holder 150. The lens tube introduction hole 153 is a circular hole having the center coinciding with the optical axis OA. As illustrated in FIG. 4, the capturing lens system 41 in which the lens tube 41b is introduced through the lens tube introduction hole 153 faces the front from the illumination device main body 100.

As illustrated in FIG. 6, the first plug hole 154 is a through hole provided in association with the first LED 132 in a periphery of the lens tube introduction hole 153. In other words, as illustrated in FIG. 7, the first plug hole 154 is disposed for each angle of 90 degrees with respect to the center of the virtual circle C1. A diameter of the first plug hole 154 is about the same as a diameter of the first light guide 134. Further, as illustrated in FIG. 5, a depth (length in the front-back direction) of the first plug hole 154 is about the same as a length of the first light guide 134. The first light guide 134 is plugged into the first plug hole 154, and is thus held in the first plug hole 154.

The second plug hole 155 is a through hole provided in association with the second LED 133 in the periphery of the lens tube introduction hole 153. In other words, as illustrated in FIG. 7, the second plug holes 155 are disposed counterclockwise at intervals of the angle θ2, the angle θ3, the angle θ2, and the angle θ3 with respect to the center of the virtual circle C2. Herein, the angle θ2 is, for example, 52 degrees, and the angle θ3 is, for example, 128 degrees. A diameter of the second plug hole 155 is about the same as a diameter of the second light guide 135. Further, a depth (length in the front-back direction) of the second plug hole 155 is about the same as a length of the second light guide 135. The second light guide 135 is plugged into the second plug hole 155, and is thus held in the second plug hole 155.

As illustrated in FIG. 5, the cover 120 that covers a periphery of a front end of the base 110 includes a cover main body 121, and a translucent plate 122 provided on a front surface of the cover main body 121. The cover main body 121 is made of, for example, a black synthetic resin, and has a space for housing the first LED substrate 115 inside the cover main body 121. A female screw 121b being screwed on the lens hood 70 is provided in an inner peripheral surface of the cover main body 121. Further, the cover main body 121 has a light emission hole 121a in a position corresponding to the LED 116. The translucent plate 122 is made of, for example, a transparent synthetic resin, and passes light from the LED 116 emitted through the light emission hole 121a, and also prevents dust particles from entering in the capturing device 1 by covering the light emission hole 121a. In this way, light from the LEDs 116 is emitted from the plurality of light emission holes 121a disposed in the circumferential direction, and thus the illumination device 4 can function as a ring flashlight.

As illustrated in FIGS. 1 and 2, the lens hood 70 has a tubular shape of a truncated cone. The lens hood 70 is made of a material that does not pass light, and is made of, for example, a polyvinyl chloride guide material or a resin such as an acrylic resin. Coating for preventing passage of light may be applied to a surface of the lens hood 70. As illustrated in FIGS. 2 and 5, a rear end of the lens hood 70 has a male screw 70a being screwed on the female screw 121b provided in the cover main body 121. The male screw 70a and the female screw 121b provided in the cover main body 121 function as a removable portion for attaching and removing the lens hood 70 to and from the cover 120.

As illustrated in FIG. 5, the diffusion plate 80 is fixed to a rear portion of the lens hood 70 by a screw that is not illustrated. As illustrated in FIG. 2, the diffusion plate 80 includes a first annular portion 81, a second annular portion 82 provided in an opening of the first annular portion 81, a connector 83 that connects an inner edge of the first annular portion 81 and an outer edge of the second annular portion 82 and extends in the up-down direction, and a diffusion film 84. The diffusion film 84 covers an opening defined by the inner edge of the first annular portion 81, the outer edge of the second annular portion 82, and the connector 83. The diffusion film 84 is provided in front of the first light guide 134 and the second light guide 135, and diffuses light emitted from the light guides. Note that an opening 85 defined by an inner edge of the second annular portion 82 and provided in front of the capturing lens system 41 is not provided with the film and is in an open state.

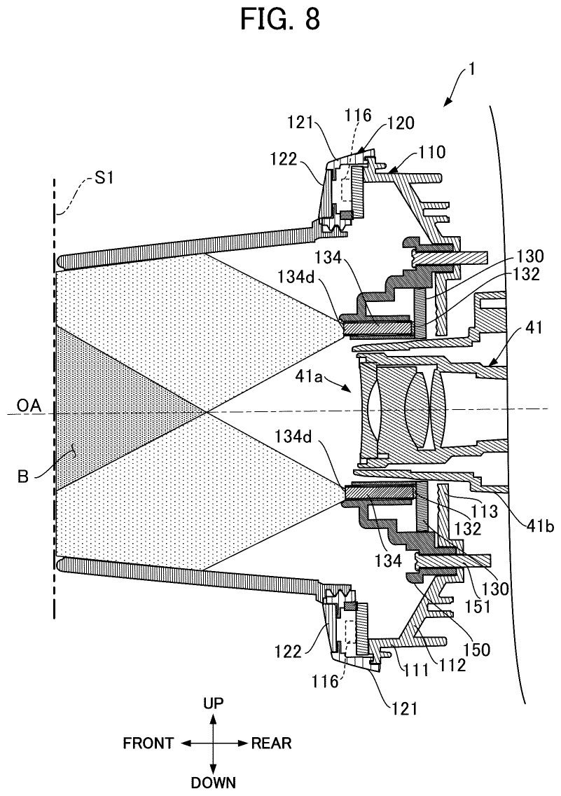

As illustrated in FIG. 8, at a time of the second capturing, the tip of the lens hood 70 is in contact with skin S1, and the skin S1 and the capturing device 1 have a predetermined positional relationship. Then, when visible light is applied, the first LED 132 is caused to emit light, and the light is guided to the front by the first light guide 134. Then, light beams substantially parallel to each other are emitted to the front from the light emission portions 134d of the plurality of the first light guides 134 provided around the front end of the capturing lens system 41. Note that the light emission portion 134d is located in the front of the front end of the capturing lens system 41. Note that, in FIG. 8, a range irradiated with light from the LED is provided with hatching, and a region irradiated more brightly is provided with darker hatching. As illustrated in FIG. 8, a region B brightly irradiated with light beams being emitted from the plurality of first LEDs 132 and overlapping each other is provided. In this way, a part of the skin S1 surrounded by the lens hood 70 is brightly irradiated with the light beams being emitted from the plurality of light sources and overlapping each other. Note that, since the lens hood 70 is made of a material that hardly passes light, the skin S1 being a portion surrounded by the lens hood 70 is less affected by external light. Thus, the skin S1 being the portion surrounded by the lens hood 70 can be effectively irradiated with light from the first LEDs 132. Then, the light reflected by the skin S1 can be incident on the capturing device 1 and guided to the capturer 40 (FIG. 5). In such a manner, a distance between the skin S1 and the capturing device 1 can be set to be fixed by pressing the lens hood 70 against the skin S1. Furthermore, brightness of the skin S1 to be illuminated can be kept at a fixed level, and an exposure condition can be stable and the like, and thus the second capturing can be stably performed.

On the other hand, when ultraviolet light is applied, the second LED 133 illustrated in FIG. 6 is caused to emit light, and the light is guided to the front by the second light guide 135. Then, light beams substantially parallel to each other are emitted to the front from the light emission portions 135d of the plurality of the second light guides 135 provided around the front end of the capturing lens system 41, and the skin S1 irradiated with ultraviolet light is captured.

Note that, whether the diffusion plate 80 is attached or not is optional according to a capturing condition. By performing capturing without the diffusion plate 80 being attached, regular reflection components (texture) from the skin S1 can be captured. On the other hand, with the diffusion plate 80 being attached, a tint changes, and a sulcus cutis and a crista cutis can be clearly captured. In this way, a different capturing condition can be provided by the presence or absence of the diffusion plate 80.

Next, actions of the capturing device 1 are described. The capturing device 1 is activated when the power button 22 (FIG. 1) is operated by a user. The activated capturing device 1 accepts setting of a capturing mode by the user via the liquid crystal monitor 11 (FIG. 1). The capturing mode includes a first capturing mode of performing the normal capturing described above, and a second capturing mode using the lens hood 70.

When the first capturing mode is selected as a capturing mode, the control unit 300 causes the LEDs 116 (FIG. 4) disposed in a ring shape to emit light. In this way, skin can be brightly irradiated with visible light. Then, when the shutter button 21 illustrated in FIG. 1 is half-pressed by the user, the control unit 300 moves the lens group of the capturing lens system 41, and automatically focuses on the skin being a capturing target. Then, when the shutter button 21 illustrated in FIG. 1 is pressed by the user, the control unit 300 captures the skin, and stores an image acquired from the first capturing. In this way, the first capturing is completed.

On the other hand, when the second capturing mode is selected as a capturing mode, the control unit 300 causes the first LEDs 132 (FIG. 6) that emit visible light to emit light. Then, when the second capturing is performed on skin irradiated with visible light by an operation of the shutter button 21 (FIG. 1) by the user, the control unit 300 then causes the second LEDs 133 (FIG. 6) that emit ultraviolet light to emit light. Then, the second capturing is performed on the skin irradiated with ultraviolet light by an operation of the shutter button 21 (FIG. 1) by the user.

As described above, according to Embodiment 1, light emitted from the first LEDs 132 and the second LEDs 133 is guided to the front by the light guides 134 and 135, and is emitted from the light emission portions around the tip of the capturing lens system 41 to the front. In this way, by guiding light to the front, the skin S1 being a capturing target can be efficiently irradiated with the emitted light without irradiating another part such as the capturing lens system 41 with the light.

Further, the light emission portions 134d and 135d can be brought as close to the tip of the capturing lens system 41 as possible, and light beams closely parallel to each other can be emitted. This can suppress parallax (in which light beams from different light sources are not parallel and are angled) caused by emitting light tilted toward an optical axis OA side from a position away from the capturing lens system 41 in order to avoid light to be applied to the capturing lens system 41.

Further, the light emission portions 134d and 135d of the light guides 134 and 135 are disposed around the capturing lens system 41 and face a front face of a capturing target. In this way, skin can be irradiated with light beams from the four light emission portions 134d from the front face while the light beams are brought close to be parallel to each other. By irradiation with the light in such a manner, a top of a crista cutis of skin can be slightly illuminated, whereas a shadow can be provided to a sulcus cutis, and thus an image in which the skin is clearly seen can be captured. Similarly, skin can also be irradiated with light beams from the four light emission portions 135d from the front face while the light beams are parallel to each other.

Since the first LEDs 132 that emit visible light and the second LEDs 133 that emit ultraviolet light are disposed, a capturing target can be irradiated with different light beams, and images having different appearances can be captured.

Further, the light emission portion 134d of the first light guide 134 that emits guided visible light is disposed on the virtual circle C1 having the center coinciding with the optical axis OA around the capturing lens system 41, and is, in other words, disposed on each vertex of the virtual square having the center coinciding with the optical axis OA. In this way, as illustrated in FIG. 8, visible light beams emitted in parallel with each other from the plurality of first LEDs 132 can overlap each other, and variations in intensity of illumination in a region irradiated with the overlapping visible light beams can be suppressed.

Similarly, the light emission portion 135d of the second light guide 135 that emits guided ultraviolet light is disposed on the virtual circle C2 having the center coinciding with the optical axis OA around the capturing lens system 41, and is, in other words, disposed on each vertex of the virtual rectangle having the center coinciding with the optical axis OA. In this way, ultraviolet light beams emitted in parallel with each other from the plurality of second LEDs 133 can overlap each other, and variations in intensity of illumination in a region irradiated with the overlapping ultraviolet light beams can be suppressed.

With the configuration in which the light guides 134 and 135 linearly extend in the front-back direction, an optical loss in the light guides 134 and 135 can be suppressed.

Further, the light guides 134 and 135 include the plurality of optical fibers. In this way, total light reflection can be achieved many times in a range of a short length of, for example, 5 mm to 10 mm in the front-back direction, and thus an emission distribution is excellent, and an irradiation distribution of the entire light guides 134 and 135 can also be excellent by tying such optical fibers in a bundle.

Since the light guides 134 and 135 are held only by being plugged into the plug holes 154 and 155 provided in the holder 150, the configuration is simple and a manufacturing cost can be reduced, and assembly work is also facilitated.

With the configuration in which the diffusion plate 80 including the diffusion film 84 is attachable to and removable from the lens hood 70, different manners of light applied to a capturing target can be easily set.

### Embodiment 2

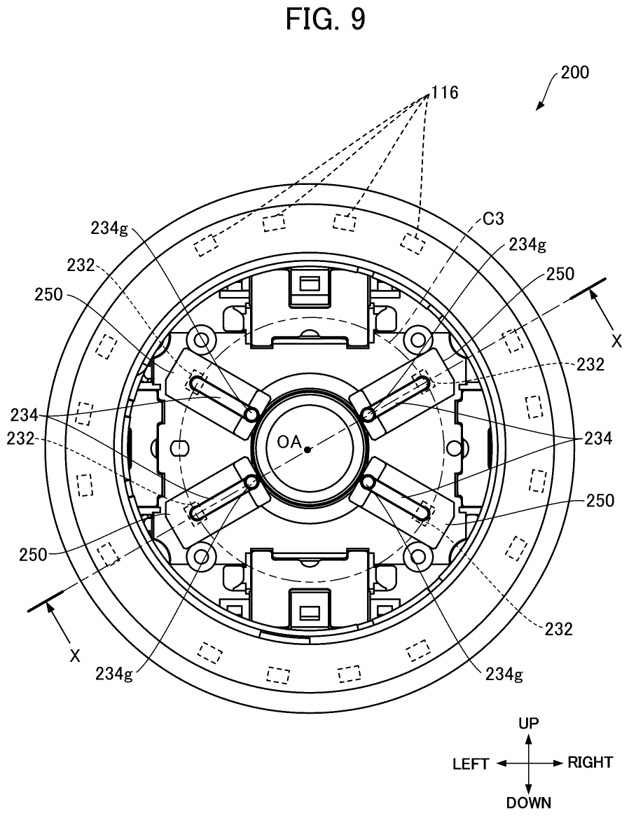

Next, Embodiment 2 is described with reference to FIGS. 9 to 11. When a capturing device 201 according to the present embodiment is compared to the capturing device 1 in Embodiment 1 described above, an arrangement of LEDs that emit light at a time of second capturing, a shape of a light guide that guides light of the LEDs, and a shape of a holder that holds the light guide are different. The other configurations are similar to those in the embodiment described above, and thus the same configurations are provided with the same reference signs, and a detailed description is omitted.

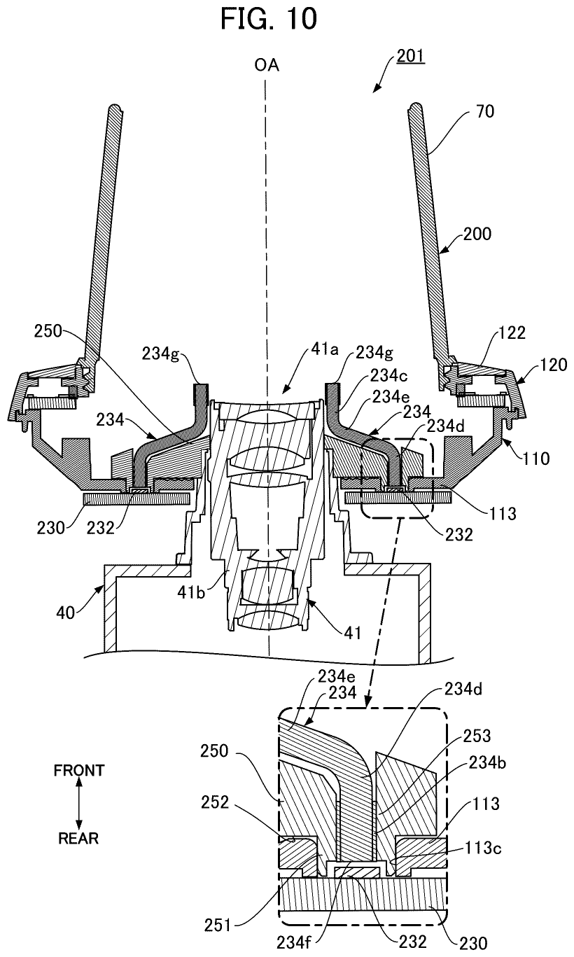

As illustrated in FIG. 10, a first LED 232 that emits light at the time of the second capturing is provided on a second LED substrate 230. The second LED substrate 230 is fastened to a rear surface of a bottom wall 113 of a base 110 with a screw. The first LED 232 emits white visible light. As illustrated in FIG. 9, the first LED 232 is disposed on a virtual circle C3 and provided on each vertex of a virtual rectangle having the center coinciding with an optical axis OA. A radius of the virtual circle C3 is larger than a radius of the virtual circle C1 and a radius of the virtual circle C2 illustrated in FIG. 7. In other words, the first LED 232 is disposed in a position farther from the optical axis OA than the first LED 132 and the second LED 133 illustrated in FIG. 7.

As illustrated in an enlarged view in FIG. 10, the bottom wall 113 has, in a position corresponding to the first LED 232, an opening 113c having a rectangular shape for exposing the first LED 232 to the front of the bottom wall 113. A protrusion 251 whose cross section protruding downward from a contact surface 252 of a holder 250 has a rectangular shape is fitted in the opening 113c. In this way, the holder 250 is fixed onto the second LED substrate 230.

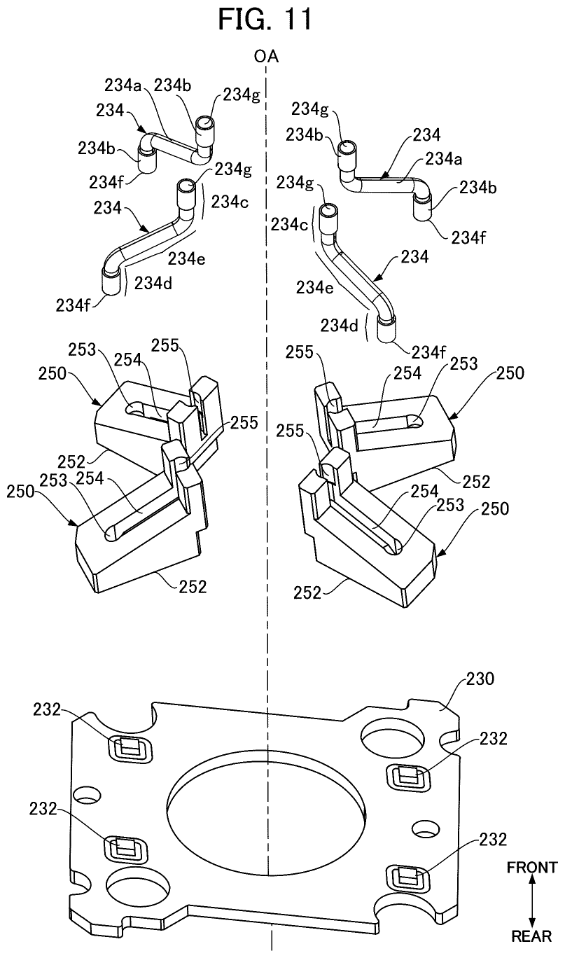

As illustrated in FIG. 11, similarly to Embodiment 1, a first light guide 234 includes an optical fiber bundle 234a including a plurality of optical fibers, and a binder 234b wound around both ends of the optical fiber bundle 234a. On the other hand, the light guide in Embodiment 1 linearly extends in the front-back direction, but, in the present embodiment, as illustrated in FIG. 10, a front portion 234c and a rear portion 234d extending in the front-back direction and an inclined portion 234e that connects the front portion 234c and the rear portion 234d are provided. The inclined portion 234e is inclined closer to the optical axis OA toward the front. In this way, light from the first LED 232 in a position away from a capturing lens system 41 is incident from a light incidence portion 234f being one end of the first light guide 234, passes through the inclined portion 234e, and is emitted to the front from a light emission portion 234g provided around a front end of the capturing lens system 41. In such a manner, the first light guide 234 brings the light from the first LED 232 close to the capturing lens system 41, guides the light to the front of the front end of the capturing lens system 41, and emits the light. A length in the front-back direction of the first light guide 234 is, for example, 5 mm to 10 mm. However, since the first light guide 234 includes the inclined portion 234e, a total length of the first light guide 234 is longer than a total length of the first light guide in Embodiment 1 described above. As illustrated in FIG. 9, when viewed from the front, the light emission portion 234g of the first light guide 234 is disposed around the capturing lens system 41 on each vertex of a virtual rectangle having the center coinciding with the optical axis OA.

The holder 250 is a member that holds the first light guide 234, and is provided in association with each first light guide 234. As illustrated in FIG. 9, the holder 250 has a substantially rectangular shape when viewed from the front, and is disposed in such a way that a longitudinal direction faces the optical axis OA. As illustrated in the enlarged view in FIG. 10, the holder 250 includes the contact surface 252 that is in contact with the bottom wall 113 and faces the rear, and the protrusion 251 whose cross section protruding to the rear has a rectangular shape is provided on the contact surface 252. A first plug portion 253 having a hole penetrating in the front-back direction is provided on the holder 250 in a position provided with the protrusion 251. As illustrated in FIG. 11, the holder 250 includes a second plug portion 254 that is connected to the first plug portion 253 and includes a groove extending obliquely forward to be closer to the optical axis OA, and a third plug portion 255 that is connected to the second plug portion 254 and extends to the front. The first light guide 234 is held by the holder 250 by the rear portion 234d plugged into the first plug portion 253, the inclined portion 234e plugged into the second plug portion 254, and the front portion 234c plugged into the third plug portion 255.

With the capturing device 201 according to the present embodiment, even when the first LED 232 is disposed away from the optical axis OA, light from the first LED 232 can be brought close to the optical axis OA by the inclined portion 234e being inclined obliquely forward. In this way, the light emission portion 234g of the light guide 234 can be disposed around the capturing lens system 41 and face a front face of a capturing target, and thus, similarly to Embodiment 1 described above, a clear image of skin can be captured, and occurrence of parallax can also be suppressed.

Further, the light emission portion 234g of the first light guide 234 that emits guided visible light is disposed around the capturing lens system 41 on each vertex of the virtual rectangle having the center coinciding with the optical axis OA. In this way, visible light beams emitted from the plurality of first LEDs 232 can overlap each other, and variations in intensity of illumination in a region irradiated with the overlapping visible light beams can be suppressed.

Since the light guide 234 is held only by being plugged into the first plug hole 253, the second plug hole 254, and the third plug hole 255 provided in the holder 250, the configuration is simple and a manufacturing cost can be reduced, and assembly work is also facilitated.

The disclosure is not limited to the embodiments described above, and various modifications and applications can be achieved. In the embodiments described above, a light source that emits visible light and a light source that emits ultraviolet light are indicated as light sources for performing the second capturing, but another light source may be provided according to a required capturing condition. Further, an arrangement of light sources is one example, and another arrangement may be used. Also, in that case, light may be guided to the front and close to the optical axis OA by the light guide.

Further, a configuration in which the light guide can be held in a predetermined pose may be achieved, and whether to adopt the holder indicated in the embodiments described above is optional. For example, the light guide may be bonded and fixed onto the LED substrate, and a holder having another shape may be used.

Further, the optical fibers are used as the light guide, but a component that can guide light from a light source to a desired position and can apply light in an excellent illumination distribution can be appropriately adopted. For example, as the light guide, a single stick-shaped light guide having a diameter equal to that of an optical fiber bundle may be adopted.

Further, the description is given that the diffusion film for diffusing light is provided on the diffusion plate attachable to and removable from the lens hood, but a film having another function, for example, a polarization film may be provided.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A capturing device comprising:
a light source that emits light applied to a capturing target;
a capturing element that captures the capturing target;
a capturing lens that couples an image of the capturing target to the capturing element;
a light guide member that guides light emitted from the light source; and
a holding member that is fixed inside the capturing device, and holds the light guide member, wherein
the light source is provided closer to the capturing element side than a tip of the capturing lens, and
the light guide member extends in parallel with an optical axis of the capturing lens, causes light from the light source to be incident on a light incidence portion, guides light in a direction parallel to the optical axis toward the tip of the capturing lens, and emits light from a light emission portion.

2. The capturing device according to claim 1, wherein
the light incidence portion of the light guide member faces the light source, and
the light emission portion of the light guide member is provided around the tip of the capturing lens.

3. The capturing device according to claim 1, wherein the light guide member includes a plurality of optical fibers tied in a bundle.

4. The capturing device according to claim 1, wherein
the light source is a plurality of light sources provided around the capturing lens, and
the light guide member is provided in association with each of the light sources.

5. The capturing device according to claim 4, wherein a part of the plurality of light sources is a light source that emits visible light, and a part of the plurality of light sources is a light source that emits ultraviolet light.

6. The capturing device according to claim 5, wherein, in a case of being viewed from the direction parallel to the optical axis, the light emission portion of the light guide member that guides visible light emitted from the light source is located around the capturing lens and has an equal distance from the optical axis.

7. The capturing device according to claim 1, wherein
a distance of the light emission portion of the light guide member from the optical axis is shorter than a distance of the light incidence portion of the light guide member from the optical axis, and
the light guide member includes an inclined portion being inclined closer to the optical axis toward the tip of the capturing lens.

8. The capturing device according to claim 1, wherein
an opening for passing the capturing lens is provided at the center of the holding member, and
a plug hole into which the light guide member is plugged is provided around the opening.

9. The capturing device according to claim 8, wherein
the plug hole is a hole penetrating in the direction parallel to the optical axis, and
the light guide member extends in parallel with the optical axis, and guides incident light in the direction parallel to the optical axis.

10. The capturing device according to claim 8, wherein
the light source is provided on a light source substrate having an opening for passing the capturing lens, and
the light source substrate is fixed to the holding member.
